(19) United States
(12) Patent Application Publication
(10) Pub. No.: US 2014/0152767 A1
(43) Pub. Date: Jun. 5, 2014

(54) METHOD AND APPARATUS FOR PROCESSING VIDEO DATA

(71) Applicant: SAMSUNG ELECTRONICS CO., LTD., Suwon-si (KR)

(72) Inventors: Sergey POMETUN, Kyiv (UA); Dmitriy DOROGOVTSEV, Kyiv (UA); Maksym KOSHEL, Kyiv (UA); Svitlana VOLKOVA, Kyiv (UA); Anton SKAKUN, Romny (UA); Daria RYZHKOVA, Boyarka (UA)

(73) Assignee: SAMSUNG ELECTRONICS CO., LTD., Suwon-si (KR)

(21) Appl. No.: 14/045,870

(22) Filed: Oct. 4, 2013

(30) Foreign Application Priority Data
Dec. 4, 2012 (KR) 10-2012-0139825

(51) Int. Cl. H04N 13/00

(52) U.S. Cl. CPC H04N 13/0011
USPC 348/43

(57) ABSTRACT

A method of compressing video signal data via three-dimensional (3D) transformation, and decoding the compressed video signal data. The method includes: receiving transformation coefficients included in video signal data compressed via 3D transformation; selecting at least one transformation coefficient from among the received transformation coefficients based on a reproducing capability of a device for reproducing the video signal data; and decoding the compressed video signal data to video signal data in a spatial domain by 3D inverse transforming the compressed video signal data using the selected at least one transformation coefficient.

### CROSS-REFERENCE TO RELATED PATENT APPLICATION

This application claims priority from Korean Patent Application No. 10-2012-0139825, filed on Dec. 04, 2012, in the Korean Intellectual Property Office, the disclosure of which is incorporated herein in its entirety by reference.

### BACKGROUND

1. Field

Exemplary embodiments relate to a method of coding video signal data, and more particularly, to a method and apparatus for compressing video signal data.

2. Description of the Related Art

Transmitting video signal data involves transmitting a large amount of video signal data and reducing signal distortion. However, when uncompressed video signal data is to be transmitted, a high bit rate is required, and thus it is difficult to transmit the uncompressed video signal data.

Accordingly, H.264 or similar codecs are used as standards for compressing video signal data. According to a method of compressing video signal data, video signal data is compressed via compression with respect to a 2-dimensional space domain and a temporal prediction method with respect to a spatial domain.

However, a resolution of a decoded image is determined based on a resolution of encoded video signal data. There is a need to increase a compression of video signal data even when the complexity of operations for compressing the video signal data are increased in accordance with the increase in operation capability of new processors.

### SUMMARY

Exemplary embodiments provide a decoding method by selecting some of transformation coefficients included in video signal data that is three-dimensionally compressed.

According to an aspect of an exemplary embodiment, there is provided a method of decoding compressed video signal data, the method including: receiving transformation coefficients included in video signal data compressed via a 3-dimensional (3D) transformation; selecting at least one transformation coefficient from among the received transformation coefficients based on a reproducing capability of a device for reproducing the video signal data; and decoding the compressed video signal data to video signal data in a spatial domain by 3D inverse transforming the compressed video signal data using the selected at least one transformation coefficient.

The compressed video signal data may be obtained by transforming the video signal data to a transformation domain with respect to a 2D spatial domain and a temporal domain.

The reproducing capability of the device may include information about a resolution of the device.

The reproducing capability of the device may include information about a frame per second (FPS) capability of the device.

The decoding may be performed regardless of a resolution of encoded video signal data.

According to an aspect of another exemplary embodiment, there is provided a decoder for decoding compressed video signal data, the decoder including: a transformation coefficient selecting unit for receiving transformation coefficients included in video signal data compressed via 3-dimensional (3D) transformation, and selecting at least one transformation coefficient from among the received transformation coefficients based on a reproducing capability of a device for reproducing the video signal data; and a decoding unit for decoding the compressed video signal data to video signal data in a spatial domain by 3D inverse transforming the compressed video signal data using the selected at least one transformation coefficient.

The compressed video signal data may be obtained by transforming the video signal data to a transformation domain with respect to a 2D space and time.

The reproducing capability of the device may include information about a resolution of the device.

The reproducing capability of the device may include information about a frame per second (FPS) capability of the device.

The decoding unit may perform decoding regardless of a resolution of encoded video signal data.

According to an aspect of an exemplary embodiment, there is provided a computer-readable recording medium having recorded thereon a program for executing the method.

According to an aspect of exemplary embodiment, there is provided a method of decoding compressed video signal data, the method including: selecting at least one transformation coefficient based on a reproducing capability of a device that reproduces video signal data; and decoding compressed video signal data to video signal data in a spatial domain by 3D inverse transforming the compressed video signal data using the selected at least one transformation coefficient.

### BRIEF DESCRIPTION OF THE DRAWINGS

The above and other features and advantages will become more apparent by describing in detail exemplary embodiments thereof with reference to the attached drawings in which:

FIG. 1 is a diagram of a structure for compressing video signal data based on three-dimensional transformation;

FIG. 2 is a diagram of a structure using a method of compressing video signal data, according to an exemplary embodiment;

FIG. 3 is a block diagram of an encoder according to an exemplary embodiment;

FIG. 4 is a block diagram of a decoder according to an exemplary embodiment;

FIG. 5 is a flowchart illustrating a method of encoding video signal data, according to an exemplary embodiment; and

FIG. 6 is a flowchart illustrating a method of decoding video signal data, according to an exemplary embodiment.

### DETAILED DESCRIPTION OF EXEMPLARY EMBODIMENTS

Hereinafter, exemplary embodiments will be described more fully with reference to the accompanying drawings. This exemplary embodiments may, however, be embodied in many different forms and should not be construed as limited to the exemplary embodiments set forth herein. Rather, the exemplary embodiments are provided so that this disclosure will be thorough and complete, and will fully convey the scope of the inventive concept to those skilled in the art. In drawings, certain elements are omitted for clarity, and like elements denote like reference numerals throughout the specification.

In the specification, when a region is “connected” to another region, the regions may not only be “directly connected”, but may also be “electrically connected” via another device therebetween. Also, when a region “includes” an element, the region may further include another element instead of excluding the other element, unless stated differently.

Hereinafter, exemplary embodiments will be described in detail with reference to accompanying drawings.

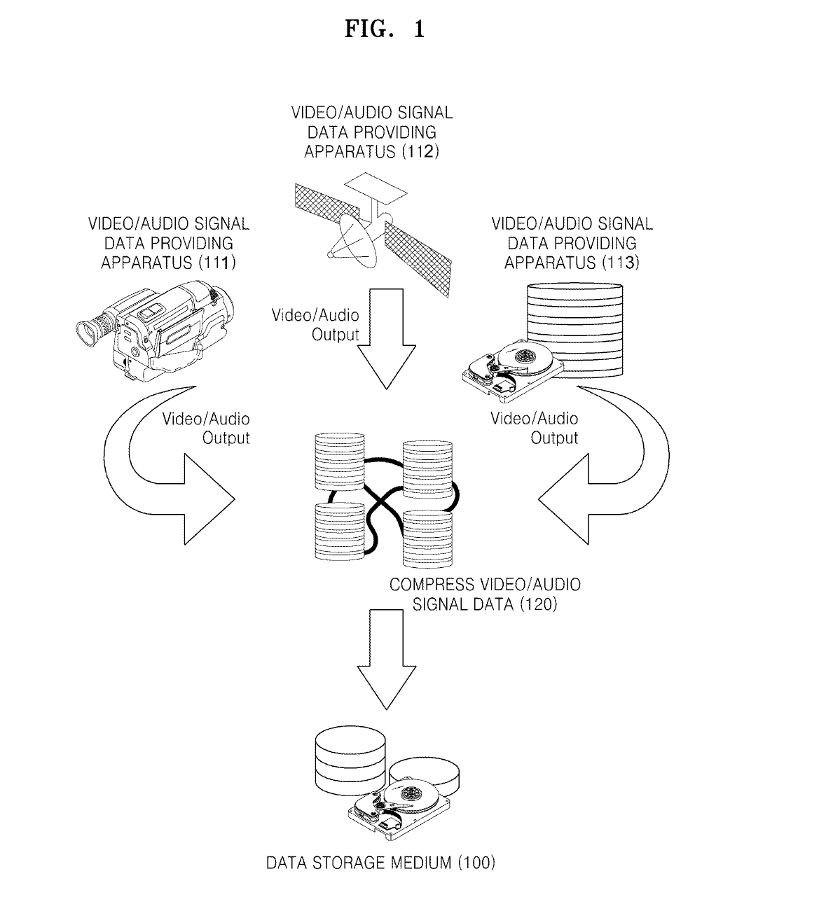

FIG. 1 is a diagram of a structure for compressing video signal data based on three-dimensional (3D) transformation.

A video/audio signal data providing apparatus provides video/audio signal data. Here, for example, the video/audio signal data providing apparatus may be a camera 111 for generating a video/audio signal, a communication apparatus 112 for transmitting a video/audio signal, or a storage medium 113 for storing a video/audio signal.

According to an exemplary embodiment, the video/audio signal data provided from the video/audio signal data providing apparatus 110 may be stored in a data storage medium 100 after the video/audio signal data is compression in operation 120.

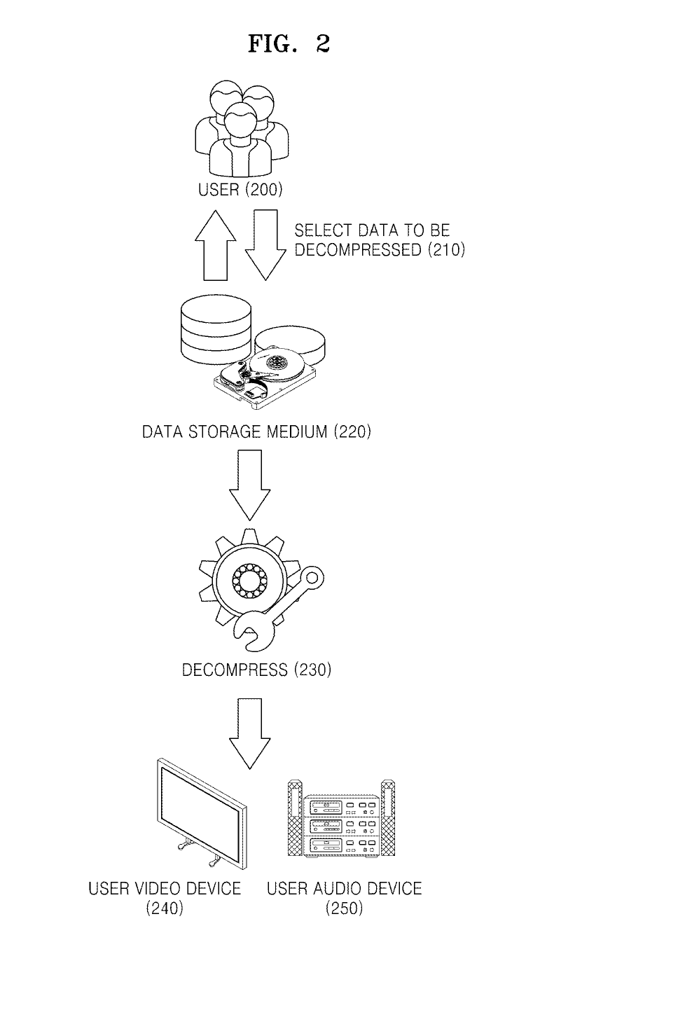

FIG. 2 is a diagram of a structure using a method of compressing video signal data, according to an exemplary embodiment.

According to an exemplary embodiment, a user 200 may select data to be decompressed from among data stored in a data storage medium 220 in operation 210.

The selected data may be reproduced by a user video device 240 or a user audio device 250 after being decompressed in operation 230.

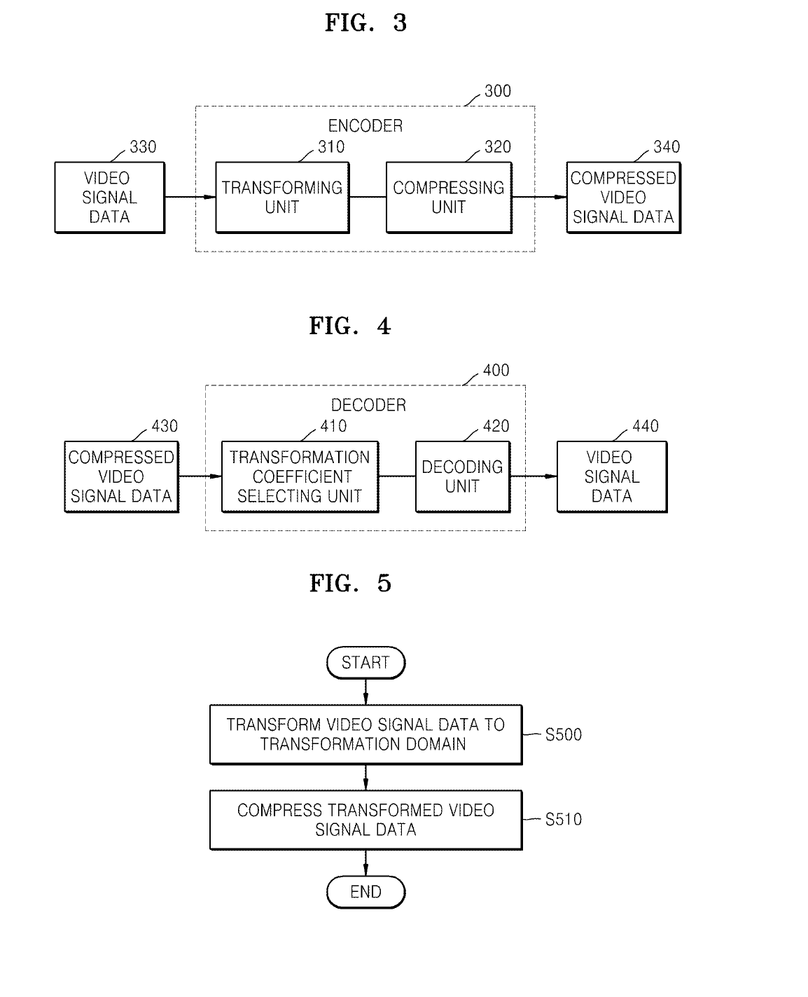

FIG. 3 is a block diagram of an encoder 300 according to an exemplary embodiment.

The encoder 300 includes a transforming unit 310 (e.g., video signal transformer) for 3D transformation of video signal data 330 from a spatial domain to a transformation domain, and a compressing unit 320 (e.g., video signal compressor) for compressing the video signal data 330 in the transformation domain to obtain compressed video signal data 340. In the specification, the video signal data may also include audio data, not only image data.

According to an exemplary embodiment, the transforming unit 310 may transform the video signal data 330 to the transformation domain with respect to a 2D space and time. In other words, the transforming unit 310 may transform the video signal data 330 to the transformation domain with respect to a height, a width, and time. Here, the video signal data 330 may be transformed to the transformation domain via any one of various transformation methods, such as wavelet transform, Laplace transform, Fourier transform, and discrete cosine transform (DCT).

According to an exemplary embodiment, the compressing unit 320 may perform filtering on the video signal data 330 transformed to the transformation domain by the transforming unit 310. Here, the compressing unit 320 may remove a high frequency component in spatial domain data via the filtering.

Also, the compressing unit 320 may quantize and compress the video signal data 330 transformed to the transformation domain of the video.

According to an exemplary embodiment, the compressed video signal data 340 may be data without information about a resolution.

FIG. 4 is a block diagram of a decoder 400 according to an exemplary embodiment.

The decoder 400 includes a transformation coefficient selecting unit 410 (e.g., transformation coefficient selector) for selecting some transformation coefficients included in compressed video signal data 430, and a decoding unit 420 (e.g., decoder) for transforming the compressed video signal data 430 in a transformation domain to video signal data 440 in a spatial domain by using the selected transformation coefficients.

The compressed video signal data 430 denotes video signal data that is 3D transformed with respect to video data in a 2D spatial domain and temporal domain. In other words, the compressed video signal data 430 is obtained by transforming video signal data to a transformation domain with respect to a height, a width, and time.

Here, according to an exemplary embodiment, the transformation coefficient selecting unit 410 may select a transformation coefficient based on the number of transformation coefficients included in the compressed video signal data 430 and reproducing capability of a device for reproducing a video. For example, the transformation coefficient selecting unit 410 may select at least one of the transformation coefficients included in the compressed video signal data 430 according to a resolution of a device capable of reproducing the video signal data 440. Alternatively, according to an exemplary embodiment, the transformation coefficient selecting unit 410 may select a transformation coefficient according to information about a frame per second (FPS) of a device for reproducing the video signal data 440.

By decoding the compressed video signal data 430 using the selected transformation coefficient, the quality of a video signal may be determined according to the reproducing capability of the device that is reproducing the video signal data 440, regardless of a resolution of the compressed video signal data 430.

According to an exemplary embodiment, the transformation coefficient selecting unit 410 may perform filtering or inverse quantization on the compressed video signal data 430, and may perform decompression on the compressed video signal data 430.

Here, the filtering may be performed to restore data generated via the filtering performed by the encoder 300.

According to an exemplary embodiment, the decoding unit 420 may decode the compressed video signal data 430 in the transformation domain to the video signal data 440 in a spatial domain and a temporal domain. In other words, the decoding unit 420 may generate the video signal data 440 that is reproducible by inverse transforming the compressed video signal data 430 in the transformation domain.

The decoding unit 420 decodes video signal data according to a transformation coefficient selected by the transformation coefficient selecting unit 410, thereby performing decoding regardless of a resolution of encoded video signal data.

FIG. 5 is a flowchart illustrating a method of encoding video signal data, according to an exemplary embodiment.

According to an exemplary embodiment, an encoder transforms video signal data to a transformation domain, in operation S500. Here, the encoder may perform 3D transformation with respect to a 3D domain of video data by adding a third temporal dimension to a 2D space.

Then, the encoder compresses the video signal data transformed to the transformation domain, in operation S510, Here, the encoder may perform filtering or quantization on the video signal data transformed to the transformation domain.

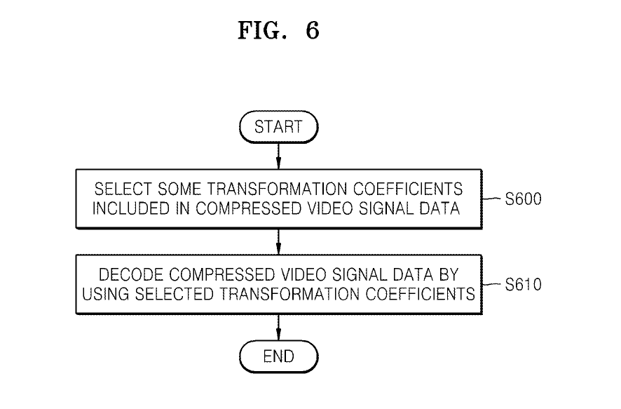

FIG. 6 is a flowchart illustrating a method of decoding video signal data, according to an exemplary embodiment.

According to an exemplary embodiment, a decoder may select some transformation coefficients included in compressed video signal data in operation S600. The compressed video signal data may be obtained by 3D compression of video signal data. Also, the decoder may perform filtering or inverse quantization on the compressed video signal data.

Here, the decoder may select the transformation coefficients based on the number of transformation coefficients included in the compressed signal data, and reproducing capability of a device for reproducing a video.

Then, the decoder may decode the compressed video signal data by using the selected transformation coefficients in operation S610. Here, the decoder may transform the video signal data in the transformation domain to video signal data in a spatial domain and a temporal domain. For example, the decoder may select some transformation coefficients included in encoded video signal data according to a resolution or information about a FPS capability of a device for reproducing decoded video signal data.

Here, the decoder may perform decoding regardless of a resolution of the encoded video signal data.

One or more exemplary embodiments may be implemented by a computer-readable recording medium, such as a program module executed by a computer. The computer-readable recording medium may be an arbitrary available medium accessible by a computer, and examples thereof include all volatile and non-volatile media and separable and non-separable media. Further, examples of the computer-readable recording medium may include a computer storage medium and a communication medium. Examples of the computer storage medium include all volatile and non-volatile media and separable and non-separable media, which have been implemented by an arbitrary method or technology, for storing information such as computer-readable commands, data structures, program modules, and other data. The communication medium typically include a computer-readable command, a data structure, a program module, other data of a modulated data signal, or another transmission mechanism, and an example thereof includes an arbitrary information transmission medium.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. Hence, it will be understood that the exemplary embodiments described above are not limiting the scope of the inventive concept. For example, each component described in a single type may be executed in a distributed manner, and components described distributed may also be executed in an integrated form.

The scope of the inventive concept is indicated by the claims which will be described in the following rather than the detailed description of the exemplary embodiments, and it should be understood that the claims and all modifications or modified forms drawn from the concept of the claims are included in the scope of the inventive concept.

What is claimed is:

1. A method of decoding compressed video signal data, the method comprising:
receiving transformation coefficients included in video signal data compressed via a three-dimensional (3D) transformation;
selecting at least one transformation coefficient from among the received transformation coefficients based on a reproducing capability of a device for reproducing the video signal data; and
decoding the compressed video signal data to video signal data in a spatial domain by 3D inverse transforming the compressed video signal data using the selected at least one transformation coefficient.

2. The method of claim 1, wherein the compressed video signal data is obtained by transforming the video signal data to a transformation domain with respect to a two-dimensional (2D) spatial domain and a temporal domain.

3. The method of claim 1, wherein the reproducing capability of the device comprises information about a resolution of the device.

4. The method of claim 1, wherein the reproducing capability of the device comprises information about a frame per second (FPS) capability of the device.

5. The method of claim 1, wherein the decoding is performed regardless of a resolution of encoded video signal data.

6. A decoder for decoding compressed video signal data, the decoder comprising:
a transformation coefficient selector which is configured to receive transformation coefficients included in video signal data compressed via three-dimensional (3D) transformation, and select at least one transformation coefficient from among the received transformation coefficients based on a reproducing capability of a device for reproducing the video signal data; and
a decoder which is configured to decode the compressed video signal data to video signal data in a spatial domain by 3D inverse transforming the compressed video signal data using the selected at least one transformation coefficient.

7. The decoder of claim 6, wherein the compressed video signal data is obtained by transforming the video signal data to a transformation domain with respect to a two-dimensional (2D) space and time.

8. The decoder of claim 6, wherein the reproducing capability of the device comprises information about a resolution of the device.

9. The decoder of claim 6, wherein the reproducing capability of the device comprises information about a frame per second (FPS) capability of the device.

10. The decoder of claim 6, wherein the decoder is configured to perform decoding regardless of a resolution of encoded video signal data.

11. A computer-readable recording medium having recorded thereon a program for executing the method of claim 1.

12. A method of decoding compressed video signal data, the method comprising:
selecting at least one transformation coefficient based on a reproducing capability of a device that reproduces video signal data; and
decoding compressed video signal data to video signal data in a spatial domain by 3D inverse transforming the compressed video signal data using the selected at least one transformation coefficient.

13. The method of claim 12, wherein the compressed video signal data is obtained by transforming the video signal data to a transformation domain with respect to a two-dimensional (2D) spatial domain and a temporal domain.

14. The method of claim 12, wherein the reproducing capability of the device comprises information about a resolution of the device.

15. The method of claim 12, wherein the reproducing capability of the device comprises information about a frame per second (FPS) capability of the device.
